(19) United States
(12) Patent Application Publication
(10) Pub. No.: US 2024/0075910 A1
(43) Pub. Date: Mar. 7, 2024

(54) BRAKE PEDAL EMULATOR

(71) Applicant: CTS Corporation, Lisle, IL (US)

(72) Inventor: Ryan Andrew Wagner, Goshen, IN (US)

(21) Appl. No.: 17/929,992

(22) Filed: Sep. 6, 2022

(51) Int. Cl. B60T 7/06; G05G 5/03

(52) U.S. Cl. CPC B60T 7/06; G05G 5/03; B60T 7/042

(57) ABSTRACT

A pedal emulator including a housing having a first housing portion that defines a first chamber and a second housing portion that defines a second chamber, the second housing portion moveable relative to the first housing portion. The pedal emulator also includes a first spring that is compressed while the second housing portion travels a first distance relative to the first housing portion, a second spring that is compressed in parallel with the first spring after the second housing travels the first distance and while the second housing portion travels a second distance relative to the first housing portion, and a third spring that is compressed in parallel with the first spring and the second spring after the second housing portion travels the second distance and while the second housing portion travels a third distance relative to the first housing portion.

### FIELD

This present disclosure relates to pedal emulators for vehicles.

### BACKGROUND

Brake-by-wire vehicle brake pedals do not utilize a conventional connection to the other components of a braking system, for example, a mechanical connection to a vacuum or hydraulic brake system. In some brake-by-wire systems, a sensor monitors how far a driver has pushed the brake pedal. This distance is used to determine the amount of braking force requested. A control unit or computer then determines how much hydraulic pressure is required, and an electric pump is used to generate that pressure and, for example, cause calipers to push on a brake disc to stop the vehicle.

### SUMMARY

Brake-by-wire systems have a number of advantages. However, brake-by-wire systems lack the “feel” of conventional brake systems that drivers are accustomed to. Accordingly, a pedal emulator that is reliable, compact, relatively inexpensive to manufacture, and capable of replicating the “feel” of a conventional brake pedal system is desired.

Aspects of the present disclosure are directed to, among other things, systems and methods for emulating the feel of a traditional brake pedal.

One example provides a pedal emulator for a vehicle, the pedal emulator including a housing including a first housing portion that defines a first chamber and a second housing portion that defines a second chamber, the second housing portion moveable relative to the first housing portion. The pedal emulator further includes a first spring that is compressed while the second housing portion travels a first distance relative to the first housing portion, a second spring that is compressed in parallel with the first spring after the second housing travels the first distance and while the second housing portion travels a second distance relative to the first housing portion, and a third spring that is compressed in parallel with the first spring and the second spring after the second housing portion travels the second distance and while the second housing portion travels a third distance relative to the first housing portion.

Another aspect provides a brake pedal assembly for a vehicle, the brake pedal assembly including a brake pedal, a bracket, a pedal arm rotatably coupled between the brake pedal and the bracket, the pedal arm arranged to rotate in response to application of a force to the brake pedal, and a pedal emulator that is compressed by the pedal arm as the pedal arm rotates. The pedal emulator includes a housing including a first housing portion and a second housing portion arranged to travel relative to the first housing portion when the pedal arm rotates, a first spring that is compressed while the second housing portion travels a first distance relative to the first housing portion, a second spring that is compressed in parallel with the first spring after the second housing travels the first distance and while the second housing portion travels a second distance relative to the first housing portion, and a third spring that is compressed in parallel with the first spring and the second spring after the second housing portion travels the second distance and while the second housing portion travels a third distance relative to the first housing portion.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate examples, instances, and/or aspects of concepts that include the claimed subject matter, and explain various principles and advantages of examples, instances, and/or aspects.

FIG. 1 is a cross-section view of a brake pedal assembly in a relaxed state, according to some examples.

FIG. 2 is a cross-section view of a brake pedal assembly in an operated state, according to some examples.

FIG. 3 is a graph illustrating the force-displacement curve of a pedal emulator, according to some examples.

FIG. 4 is a cross-section view of a pedal emulator in an uncompressed state, according to some examples.

FIG. 5 is a cross-section view of a pedal emulator in a compressed state, according to some examples

FIG. 6 is a spring diagram of a pedal emulator when no braking force is applied to the pedal emulator, according to some examples.

FIG. 7 is a spring diagram of the pedal emulator compressed by a first amount, according to some examples.

FIG. 8 is a spring diagram of the pedal emulator compressed by a second amount, according to some examples.

FIG. 9 is a spring diagram of a fully compressed pedal emulator, according to some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples.

The apparatus and method components have been represented where appropriate by conventional symbols in the drawings, showing only those specific details that are pertinent to understanding the examples, instances, and aspects illustrated so as not to obscure the disclosure with details that will be readily apparent to those of ordinary skill in the art having the benefit of the description herein.

### DETAILED DESCRIPTION

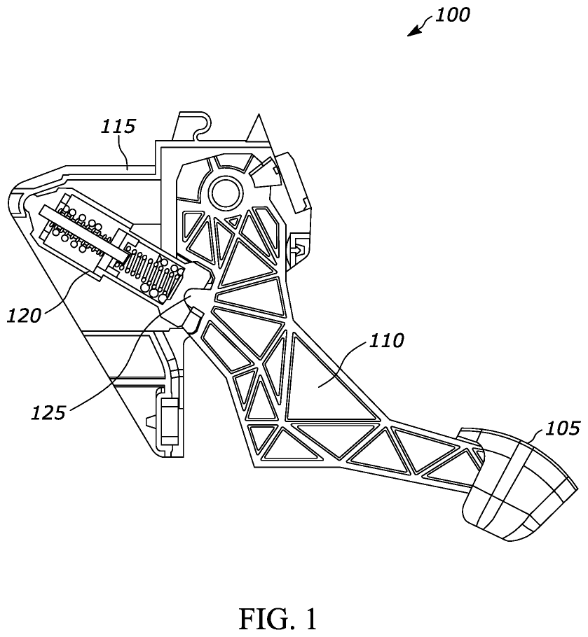

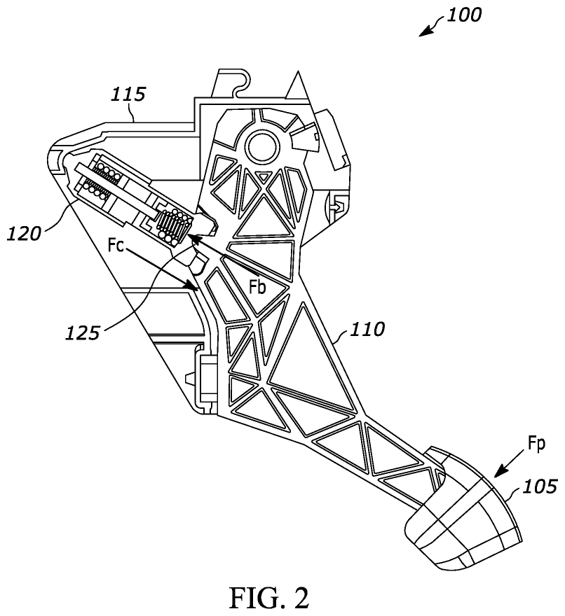

FIGS. 1 and 2 illustrate cross-sectional views of a brake pedal assembly 100 according to some aspects. The brake pedal assembly 100 includes, among other things, a brake pedal 105 that is coupled to an end of a pedal arm 110. The pedal arm 110 is rotatably coupled to a bracket 115 included in the brake pedal assembly 100, such that the pedal arm 110 rotates relative to the bracket 115 when a brake pedal force Fₚ is applied to the brake pedal 105. FIG. 1 illustrates the brake pedal assembly 100 in a relaxed state in which no brake pedal force Fₚ has been applied to the brake pedal 105. FIG. 2 illustrates the brake pedal assembly 100 in an operated or braking state in which a brake pedal force Fₚ has been applied to the braked pedal 105, thereby causing rotation of the of the pedal arm 110 relative to the bracket 115.

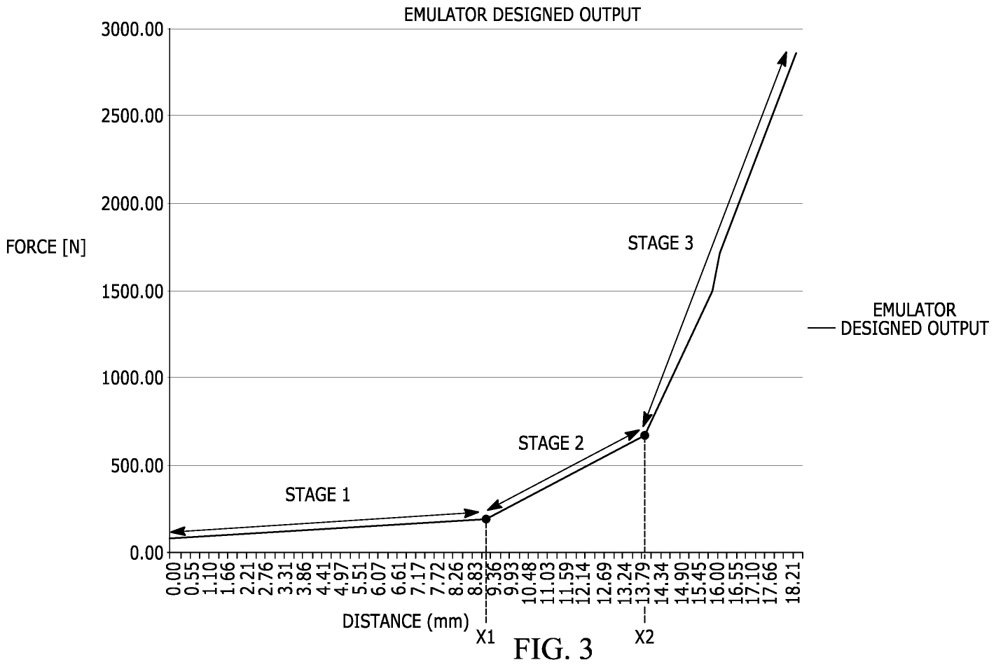

As also shown in FIGS. 1 and 2, the brake pedal assembly 100 is operatively coupled to a pedal emulator 120 that is designed to replicate the feel of a conventional braking system. As will be described in more detail below, the pedal emulator 120 is linearly compressed in response to the application of a brake pedal force Fₚ to the braked pedal 105. For example, when a brake pedal force Fₚ is applied to the brake pedal 105, the pedal arm 110 rotates and engages, by an actuating member 125, the pedal emulator 120. As the pedal arm 110 rotates, the actuating member 125 imparts a braking force F_{b}, which is proportional to the brake pedal force Fₚ, onto the pedal emulator 120 thereby causing the pedal emulator 120 to compress. As the pedal arm 110 rotates and applies the braking force F_{b} onto the pedal emulator 120, the pedal emulator 120 compresses and produces a counter-force F_{c} that resists the rotation of the pedal arm 110. That is, the pedal emulator 120 produces a counter-force F_{c} that replicates the feel of a traditional braking system when a brake pedal force Fₚ is applied to the brake pedal 105. FIG. 3 illustrates an example force curve 300 of the force output of pedal emulator 120 versus the linear compression of the pedal emulator 120.

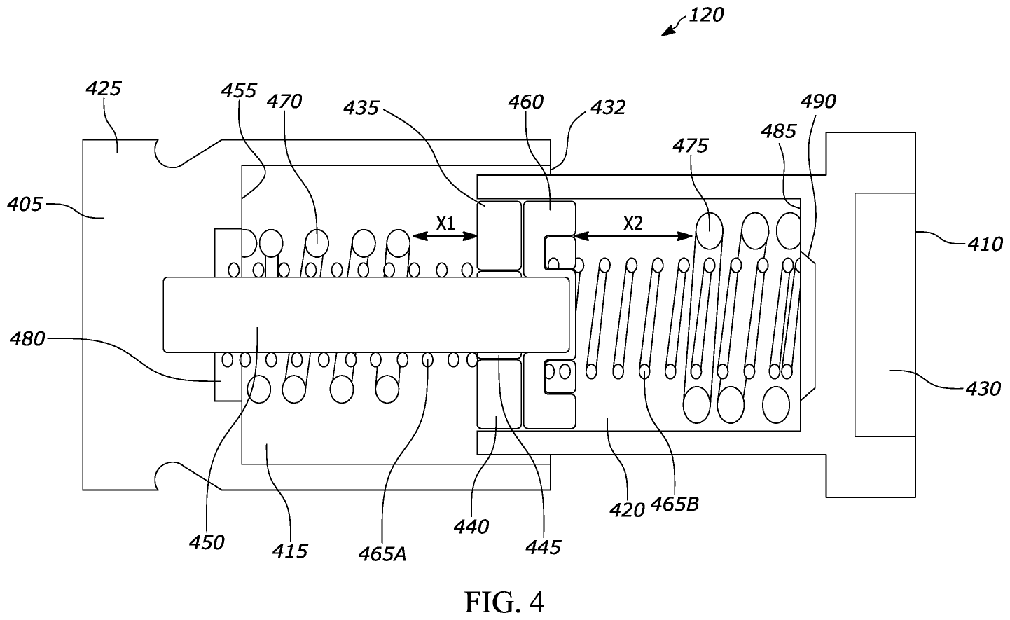

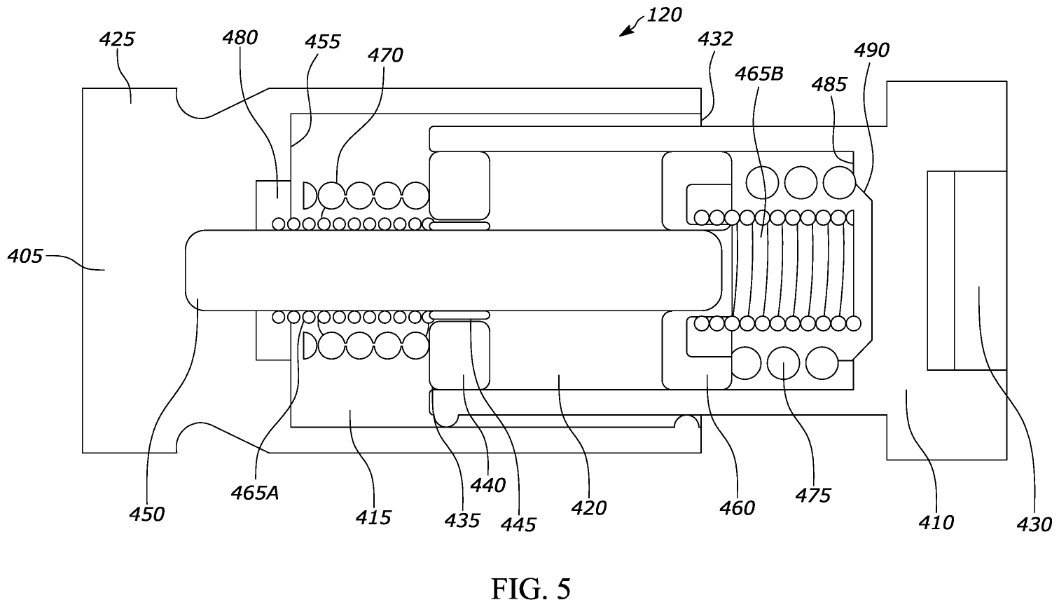

FIGS. 4 and 5 illustrate cross-sectional views of the pedal emulator 120 according to some aspects. FIG. 4 illustrates a cross-sectional view in which the pedal emulator 120 is in a fully relaxed, or uncompressed, state and FIG. 5 illustrates a cross-sectional view in which the pedal emulator 120 is in a compressed state. The pedal emulator 120 includes, among other things, a cylindrical housing having a first, or outer, housing portion 405 and a second, or inner, housing portion 410 that is operable to move relative to the outer housing portion 405. The outer housing portion 405 defines a first cylindrical chamber 415 and the inner housing portion 410 defines a second cylindrical chamber 420. When the pedal emulator 120 is in the relaxed state (FIG. 4), the inner housing portion 410 extends almost fully outwards from the first chamber 415 of the outer housing portion 405. However, as shown in FIG. 5, the inner housing portion 410 slides into the first chamber 415 when the pedal emulator 120 is in a compressed state. The diameter of the first chamber 415 is larger than the diameter of the inner housing portion 410 such that the inner housing portion 410 is received by the first chamber 415 during compression of the pedal emulator 120.

In operation, the outer housing portion 405 is secured to the bracket 115 such that the outer housing portion 405 is stationary relative to the brake pedal assembly 100. For example, the outer housing portion 405 includes a shroud 425 or similar structure that is used to mount the outer housing portion 405 to the bracket 115. In contrast, the inner housing portion 410 is coupled with the pedal arm 110 such that rotation of the pedal arm 110 causes movement of the inner housing portion 410 relative to the brake pedal assembly 100. In the illustrated example, the actuating member 125 of the pedal arm engages a notch 430 formed in the inner housing portion 410 thereby causing linear movement of the inner housing portion 410 as the pedal arm 110 rotates. Accordingly, when a brake pedal force Fₚ is applied to the brake pedal 105, rotation of the pedal arm 110 forces the inner housing portion 410 to compress, or slide, into the first chamber 415 of the outer housing portion 405 (FIG. 2).

As shown in FIGS. 4 and 5, the inner housing portion 410 is received by the open end 432 of the first housing portion 405. As further shown in FIGS. 4 and 5, the open end 435 of the second chamber 420 is sealed with a gland 440. An aperture formed in the center of the gland 440 is fitted with a bushing 445 that is arranged to receive a piston shaft 450. A first end of the piston shaft 450 is coupled to the closed end 455 of the first chamber 415 and a second end of the piston shaft 450 extends through the bushing 445 into the second chamber 420. That is, the piston shaft 450 extends longitudinally through the length of the first chamber 415 and through the bushing 445 into the second chamber 420. The second end of the piston shaft 450, which extends into the second chamber 420, is fitted with a piston cap 460. When the pedal emulator 120 is in the relaxed, or uncompressed, state (FIG. 4), the piston cap 460 abuts against the gland 440. However, as the pedal emulator 120 is compressed and the inner housing portion 410 slides into the first chamber 415, the gland 440 becomes linearly displaced from the piston cap 460 (FIG. 5). That is, the gland 440 slides along the piston shaft 450 away from the piston cap 460 and further into the first chamber 415 as the braking force F_{b} is applied to the pedal emulator 120.

The pedal emulator 120 also includes a spring system that is contained within the first and second chambers 415, 420 of the cylindrical housing. In the illustrated example, the spring system includes two first stage springs 465A, 465B, a second stage spring 470, and a third stage spring 475. As will be described in more detail below, the springs 465A, 465B, 470, and 475 are connected in a quasi-parallel arrangement meaning that one or more of the springs are compressed in parallel at a given time as the pedal emulator 120 is compressed by the pedal arm 110. When the spring system is compressed during operation of the brake pedal assembly 100, the pedal emulator 120 generates a counterforce F_{c} that follows the force curve 300 illustrated in FIG. 3.

The first stage spring 465A and the second stage spring 470 are disposed within the first chamber 415 defined by the outer housing portion 405. In one aspect, the first stage spring 465A and the second stage spring 470 are arranged coaxially around the piston shaft 450 within the first chamber 415. In the illustrated example, the diameter of the second stage spring 470 is larger than the diameter of the first stage spring 465A such that the second stage spring 470 also coaxially surrounds the first stage spring 465A. The relaxed, or uncompressed, length of the first stage spring 465A is longer than the relaxed length of the second stage spring 470. As shown, when the pedal emulator 120 is in a relaxed, or uncompressed, state (FIG. 4), the first stage spring 465A is held in place between the gland 440 and the closed end 455 of the first chamber 415. That is, a first end of the first stage spring 465A abuts against the closed end 455 of the first chamber 415 and a second end of the first stage spring 465A abuts against the gland 440 while the pedal emulator 120 is in the relaxed state. As a result, no mechanical fasteners or adhesives are needed to hold the first stage spring 465A in place within the first chamber 415. Accordingly, less components can be used to construct the pedal emulator 120 thereby reducing the cost and complexity of manufacturing the pedal emulator 120.

However, unlike the first stage spring 465A, the second stage spring 470 is not long enough to contact both the closed end 455 of the first chamber 415 and the gland 440 while the pedal emulator 120 is in the relaxed state. Instead, as shown in FIG. 4, a first end of the second stage spring 470 is held in place by a first retainer 480 at the closed end 455 of the first chamber 415 while a second end of the second stage spring 470 is spaced apart from the gland 440 by a first distance X₁. Accordingly, and as will be described in more detail below, the gland 440 travels the first distance X₁ during compression of the pedal emulator 120 before the second stage spring 470 is engaged by the gland 440. In some instances, the first retainer 480 is coupled to the closed end 455 of the first chamber 415 via a friction fit. For example, the first retainer 480 may be seated within a notch formed in the closed end 455 of the first chamber 415. In such instances, no adhesives or mechanical fasteners are needed to hold the first retainer 480 in place while the pedal emulator 120 is in the relaxed state. In other instances, the first retainer 480 is coupled to the closed end 455 of the first chamber 415 using adhesives and/or mechanical fasteners.

As also shown in FIGS. 4 and 5, the first stage spring 465B and the third stage spring 475 are disposed within the second chamber 420 defined by the inner housing portion 410. The relaxed, or uncompressed, length of the first stage spring 465B is longer than the relaxed length of the third stage spring 475. Accordingly, as shown in FIG. 4, when the pedal emulator 120 is in a relaxed, or uncompressed, state, the first stage spring 465B is held in place between the piston cap 460 and the closed end 485 of the first chamber 415. That is, a first end of the first stage spring 465B abuts against the closed end 485 of the second chamber 420 and a second end of the first stage spring 465B abuts against the piston cap 460 while the pedal emulator 120 is in the relaxed state. By this regard, no mechanical fasteners or adhesives are used to hold the first stage spring 465B in place within the first chamber 420. Rather, as shown, the first stage spring 465B is merely held in place by the tensile force applied by the first stage spring 465B onto the closed end 485 of the second chamber 420 and the piston cap 460. Accordingly, the pedal emulator 120 can be manufactured at a reduced cost and complexity when compared to pedal emulators that include various additional components.

Unlike the first stage spring 465B, the third stage spring 475 is not long enough to contact both the closed end 485 of the second chamber 420 and the piston cap 460 while the pedal emulator 120 is in the relaxed state. Rather, as shown in FIG. 4, a first end of the third stage spring 475 is held in place by a second retainer 490 disposed at the closed end 485 of the second chamber 420 while a second end of the third stage spring 475 is spaced apart from the piston cap 460 by a second distance X₂. The second distance X₂ is larger than the first distance X₁, and the inner housing portion 410 travels the second distance X₂ into the first chamber 415 during compression of the pedal emulator 120 before the third stage spring 475 engages the piston cap 460. In some instances, the second retainer 490 is coupled to the closed end 485 of the second chamber 420 via a friction fit. For example, the second retainer 490 may be seated within a notch formed in the closed end 485 of the second chamber 420. In such instances, no adhesives or mechanical fasteners are needed to hold the second retainer 490 in place while the pedal emulator 120 is in the relaxed state. In other instances, the second retainer 490 is coupled to the closed end 485 of the second chamber 420 using adhesives and/or mechanical fasteners.

In some instances, the first stage springs 465A, 465B are implemented as springs that have approximately the same spring constant. In other instances, the first stage springs 465A, 465B have different spring constants. In some instances, the second stage spring 470 has a spring constant that is greater than the respective spring constants of the first stage springs 465A, 465B. In such instances, the second stage spring 470 has a stronger spring characteristic than the first stage springs 465A, 465B. In some instances, the third stage spring 475 has a spring constant that is greater than the respective spring constants of the first stage springs 465A, 465B and the second stage spring 470. Accordingly, in such instances, the third stage spring 475 has the strongest spring characteristic when compared to the first stage springs 465A, 465B and the second stage spring 470.

As described above, the pedal emulator 120 outputs a counter-force F_{c} that mimics the feel of a conventional brake pedal when actuated by the pedal arm 110 during a braking event. The counter-force F_{c}, which is modeled by the force curve 300 shown in the illustrated example of FIG. 3, varies with respect to travel of the inner housing portion 410 into the first chamber 415. As shown in FIG. 3, the force curve 300 exhibits two inflection points, such that the rate of change of the counter-force F_{c} varies non-linearly through full compression of the spring system included in the pedal emulator 120. As further shown in FIG. 3, the counter-force F_{c} output by the pedal emulator 120 includes three stages: a first stage force response, a second stage force response, and a third stage force response. As used herein, the term “force response” means the cumulative counter-force F_{c} produced by the pedal emulator 120 through a given amount of travel of the inner housing portion 410. It should be understood that the counter-force F_{c} produced by the pedal emulator 120 is approximately equal in magnitude and opposite in direction to the amount of braking force F_{b} applied to the pedal emulator 120.

The first stage force response of the pedal emulator 120 is provided by the first stage springs 465A, 465B compressed in parallel. The second stage force response of the pedal emulator 120 is provided by the first stage springs 465A, 465B compressed in parallel with the second stage spring 470. The third stage force response of the pedal emulator 120 is provided by the first stage springs 465A, 465B, the second stage spring 470, and the third stage spring 475 compressed in parallel with each other. Each force response stage is discussed below in connection with FIG. 3 and FIGS. 6-9, in which a braking force F_{b} applied to the pedal emulator 120 is depicted.

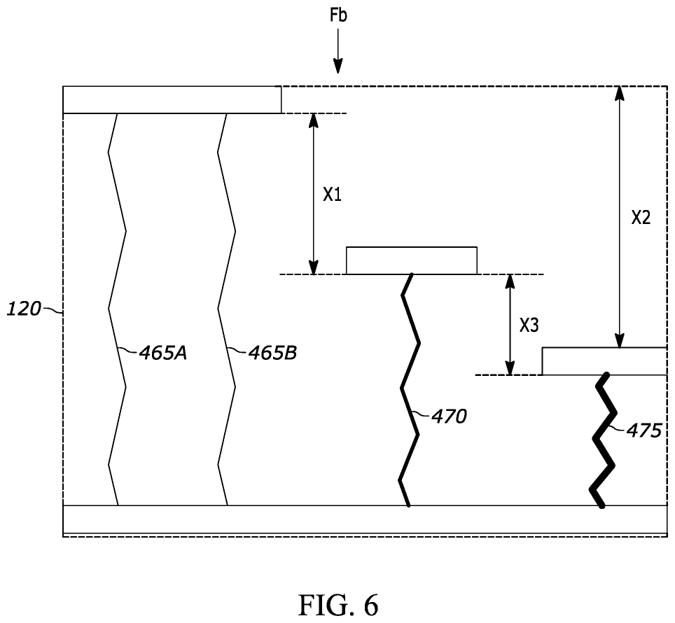

FIG. 6 illustrates the spring system included in pedal emulator 120 just before a braking force F_{b} is applied to the pedal emulator 120. Before any braking force F_{b} is applied to the pedal emulator 120 by the pedal arm 110, the pedal emulator 120 is in a relaxed, or uncompressed, state. Consequently, the pedal emulator 120 outputs little to no counter-force F_{c} while in the relaxed state. Upon the application of a braking force F_{b} to the uncompressed pedal emulator 120, the pedal emulator 120 outputs a first stage force response. The first stage force response is produced as the first stage springs 465A, 465B are compressed in parallel for the first distance X₁. That is, the first stage springs 465A, 465B output, in parallel, a counter-force F_{c} in accordance with the first stage of the force curve 300 while the inner housing portion 410 travels the first distance X₁ into the first chamber 415.

For example, the first stage spring 465A is compressed between the closed end 455 of the first chamber 415 and the gland 440, and the first stage spring 465B is compressed between the closed end 485 of the second chamber 420 and the piston cap 460 during the first stage force response of the pedal emulator 120. However, neither the second stage spring 470 nor the third stage spring 475 are engaged and/or compressed during the first stage force response of the pedal emulator 120. As further shown in FIG. 3, the first stage counter-force F_{c} increases with the linear travel of the inner housing portion 410 into the first chamber 415. Therefore, the first stage force response of the pedal emulator 120 is dependent upon the position of the inner housing portion 410 and the respective spring constants of the parallel-connected first stage springs 465A, 465B.

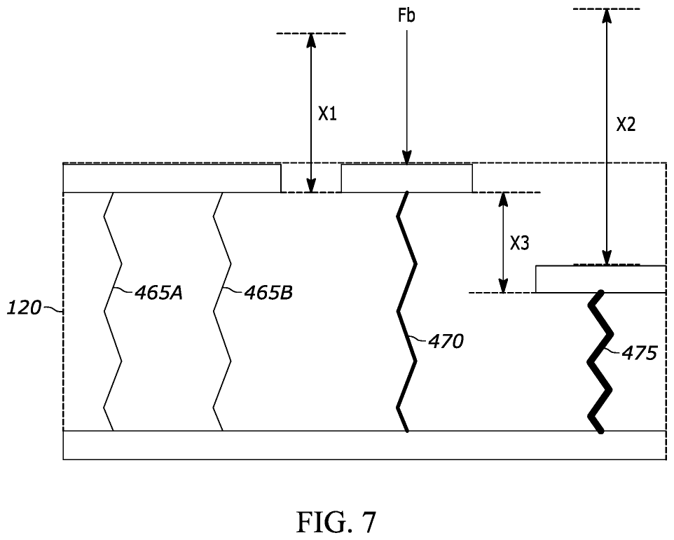

Once the inner housing portion 410 travels the first distance X₁ into the first chamber 415, the counter-force F_{c} output by the pedal emulator 120 reaches a first inflection point at which the gland 440 engages the second stage spring 470. Referring now to FIGS. 3 and 7, the continued input of the braking force F_{b} results in the second stage force response of the pedal emulator 120. The second stage force response is produced by the first stage springs 465A, 465B and the second stage spring 470 compressed in parallel for the third distance X₃, where X₃ is the difference between the first and second distances X₁, X₂. That is, the first stage springs 465A, 465B and the second stage spring 470 output, in parallel, a counter-force F_{c} in accordance with the second stage of the force curve 300 as the inner housing portion 410 travels the third distance X₃ past the first distance X₁ into the first chamber 415.

For example, the first stage spring 465A and second stage spring 470 are compressed between the closed end 455 of the first chamber 415 and the gland 440, and the first stage spring 465B is compressed between the closed end 485 of the second chamber 420 and the piston cap 460 during the second stage force response of the pedal emulator 120. However, the third stage spring 475 is not engaged and/or compressed during the second stage force response of the pedal emulator 120. Also, as shown in FIG. 3, the second stage counter-force F_{c} increases, at a faster force rate (e.g., force per unit travel) than that of the first stage counter-force F_{c}, with the linear travel of the inner housing portion 410 into the first chamber 415. Therefore, the second stage force response of the pedal emulator 120 is dependent upon the position of the inner housing portion 410 and the respective spring constants of the parallel-connected first stage springs 465A, 465B and second stage spring 470.

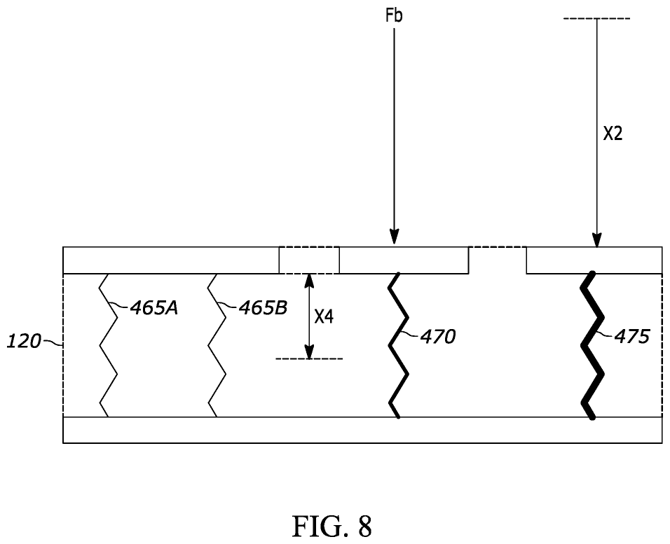

Once the inner housing portion 410 travels the second distance X₂ into the first chamber 415, the counter-force F_{c} output by the pedal emulator 120 reaches a second inflection point at which the third stage spring 475 engages the piston cap 460. Referring now to FIGS. 3 and 8, the continued input of the braking force F_{b} results in the third stage force response of the pedal emulator 120. The third stage force response is produced by the first stage springs 465A, 465B, the second stage spring 470, and the third stage spring 475 compressed in parallel for a fourth distance X₄. That is, the first stage springs 465A, 465B, the second stage spring 470, and the third stage spring 475 output, in parallel, a counter-force F_{c} in accordance with the third stage of the force curve 300 as the inner housing portion 410 travels the fourth distance X₄ past the second distance X₂ into the first chamber 415.

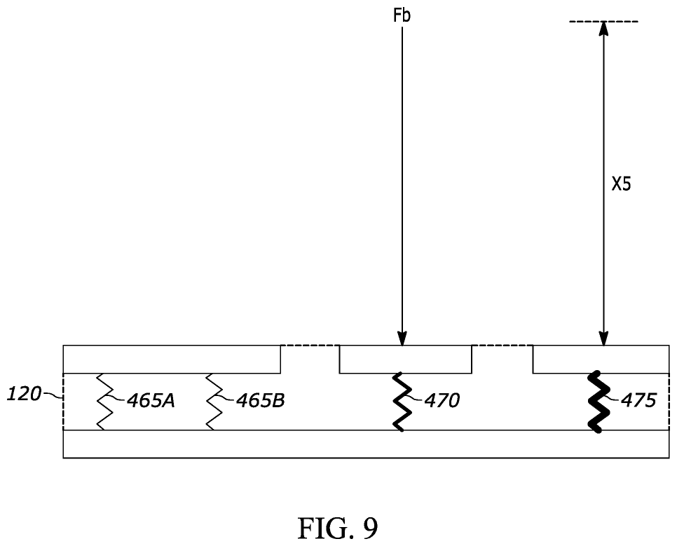

For example, the first stage spring 465A and second stage spring 470 are compressed between the closed end 455 of the first chamber 415 and the gland 440, and the first stage spring 465B and the third stage spring 475 are compressed between the closed end 485 of the second chamber 420 and the piston cap 460 during the third stage force response of the pedal emulator 120. As shown in FIG. 3, the third stage counter-force F_{c} increases, at a faster force rate than that of the first and second stage counter-forces F_{c}, with the linear travel of the inner housing portion 410 further into the first chamber 415. Therefore, the third stage force response of the pedal emulator 120 is dependent upon the position of the inner housing portion 410 and the respective spring constants of the parallel-connected first stage springs 465A, 465B, second stage spring 470, and third stage spring. Once the inner housing portion 410 travels the fourth distance X₄ into the first chamber 415 during the third stage force response, the pedal emulator 120 becomes fully compressed (FIG. 9) at which point the inner housing portion 410 has traveled a total distance of X₅.

As described above, the pedal emulator 120 includes two first stage springs 465A, 465B connected in parallel. The two first stage springs 465A, 465B provide redundancy such that failure of one of the first stage springs 465A, 465B does not have a significant negative impact on performance of the pedal emulator 120. However, in some instances, the pedal emulator 120 includes only a single first stage spring 465. In some instances, the pedal emulator 120 also includes redundant second and/or third stage springs 470, 475 similar to the redundant first stage springs 465A, 465B described herein. In some instances, the pedal emulator 120 includes additional stages of springs, such as fourth, fifth, and/or sixth stage springs. In such instances, the pedal emulator 120 experiences additional stages of force response during operation of the brake pedal assembly 100.

In the foregoing specification, specific examples have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A pedal emulator comprising:
a housing including:
a first housing portion that defines a first chamber; and
a second housing portion that defines a second chamber, the second housing portion moveable relative to the first housing portion;
a first spring that is compressed while the second housing portion travels a first distance relative to the first housing portion;
a second spring that is compressed in parallel with the first spring after the second housing portion travels the first distance and while the second housing portion travels a second distance relative to the first housing portion; and
a third spring that is compressed in parallel with the first spring and the second spring after the second housing portion travels the second distance and while the second housing portion travels a third distance relative to the first housing portion.

2. The pedal emulator of claim 1, wherein the first spring and the second spring are contained within the first chamber; and
wherein the second spring is engaged by the second housing portion after the second housing portion travels the first distance relative to the first housing portion.

3. The pedal emulator of claim 2, wherein an open end of the second housing portion is received by an open end of the first housing portion; and
wherein the open end of the second housing portion is sealed by a gland.

4. The pedal emulator of claim 3, wherein the first spring is compressed between the gland and a closed end of the first housing portion as the second housing portion travels the first distance; and
wherein the second spring is compressed in parallel with the first spring between the gland and the closed end of the first housing portion after the second housing portion travels the first distance.

5. The pedal emulator of claim 3, further comprising a piston including:
a shaft that extends from the first chamber into the second chamber through an aperture formed in the gland; and
a cap fitted on the end of the shaft disposed in the second chamber, the cap abutting against the gland before the second housing portion travels relative to the first housing portion.

6. The pedal emulator of claim 5, wherein the first and second springs are arranged coaxially along the shaft.

7. The pedal emulator of claim 5, wherein the third spring is contained within the second chamber; and
wherein the third spring is compressed between the cap and a closed end of the second housing portion after the second housing portion travels the second distance relative to the first housing portion.

8. The pedal emulator of claim 5, further comprising a fourth spring contained within the second chamber; and
wherein the fourth spring is compressed in parallel with the first spring as the second housing portion travels the first distance relative to the first housing portion.

9. The pedal emulator of claim 1, wherein a first end of the second spring is coupled to a first retainer that is disposed at a closed end of the first chamber and a second end of the second spring is spaced the first distance from the second housing portion in a fully relaxed position of the pedal emulator; and
wherein a first end of the third spring is coupled to a second retainer that is disposed at a closed end of the second chamber.

10. The pedal emulator of claim 1, wherein a spring constant of the third spring is greater than a spring constant of the first spring and a spring constant of the second spring.

11. A brake pedal assembly comprising:
a brake pedal;
a bracket;
a pedal arm rotatably coupled between the brake pedal and the bracket, the pedal arm arranged to rotate in response to application of a force to the brake pedal; and
a pedal emulator that is compressed by the pedal arm as the pedal arm rotates, the pedal emulator including:
a housing including a first housing portion and a second housing portion arranged to travel relative to the first housing portion when the pedal arm rotates;
a first spring that is compressed while the second housing portion travels a first distance relative to the first housing portion;
a second spring that is compressed in parallel with the first spring after the second housing travels the first distance and while the second housing portion travels a second distance relative to the first housing portion; and
a third spring that is compressed in parallel with the first spring and the second spring after the second housing portion travels the second distance and while the second housing portion travels a third distance relative to the first housing portion.

12. The brake pedal assembly of claim 11, wherein the first spring and the second spring are contained within a first chamber defined by the first housing portion; and
wherein the second spring is engaged by the second housing portion after the second housing portion travels the first distance relative to the first housing portion.

13. The brake pedal assembly of claim 12, wherein an open end of the second housing portion is received by an open end of the first housing portion; and
wherein the open end of the second housing portion is sealed by a gland.

14. The brake pedal assembly of claim 13, wherein the first spring is compressed between the gland and a closed end of the first housing portion as the second housing portion travels the first distance; and
wherein the second spring is compressed in parallel with the first spring between the gland and the closed end of the first housing portion after the second housing portion travels the first distance.

15. The brake pedal assembly of claim 13, wherein the second housing portion defines a second chamber.

16. The brake pedal assembly of claim 15, further comprising a piston including:
a shaft that extends from the first chamber into the second chamber through an aperture formed in the gland; and
a cap fitted on the end of the shaft disposed in the second chamber, the cap abutting against the gland before the second housing portion travels relative to the first housing portion.

17. The brake pedal assembly of claim 16, wherein the third spring is contained within the second chamber; and
wherein the third spring is compressed between the cap and a closed end of the second housing portion after the second housing portion travels the second distance relative to the first housing portion.

18. The brake pedal assembly of claim 16, further comprising a fourth spring contained within the second chamber; and
wherein the fourth spring is compressed in parallel with the first spring as the second housing portion travels the first distance relative to the first housing portion.

19. The brake pedal assembly of claim 11, wherein a first end of the second spring is coupled to a first retainer that is disposed at a closed end of the first chamber and a second end of the second spring is spaced the first distance from the second housing portion in a fully relaxed position of the pedal emulator; and
wherein a first end of the third spring is coupled to a second retainer that is disposed at a closed end of the second chamber.

20. The brake pedal assembly of claim 11, wherein a spring constant of the third spring is greater than a spring constant of the first spring and a spring constant of the second spring.
